(19) United States
(12) Patent Application Publication
(10) Pub. No.: US 2023/0264780 A1
(43) Pub. Date: Aug. 24, 2023

(54) USER INTERFACE ASSEMBLY OF VEHICLE, DRIVE SYSTEM OF VEHICLE, AND ELECTRIC ASSISTED BICYCLE

(71) Applicant: Yamaha Hatsudoki Kabushiki Kaisha, Shizuoka (JP)

(72) Inventors: Norihiro MOROZUMI, Shizuoka (JP); Masatsugu UDA, Shizuoka (JP)

(21) Appl. No.: 18/169,884

(22) Filed: Feb. 16, 2023

(30) Foreign Application Priority Data
Feb. 18, 2022 (JP) 2022-023981

(51) Int. Cl. B62M 6/45; B62M 6/90; B60K 37/02

(52) U.S. Cl. CPC B62M 6/45; B62M 6/90; B60K 37/02

(57) ABSTRACT

A UI assembly includes a UI device, a cradle, an operation member having an operating portion for a user to operate. A first engaging portion is formed on the cradle. The operation member is formed separately from and detachable from the UI device. The operation member includes a second engaging portion. The second engaging portion is engaged with the first engaging portion 61a to prevent the UI device from separating from the cradle, and is movable with the operating portion so that the first engaging portion and the second engaging portion are disengaged from each other. This provides a user interface (UI) assembly that allows a user to continuously use the cradle and the user interface device even if an unintended external force acts on the operating portion.

### CROSS-REFERENCE TO RELATED APPLICATION

The present application claims priority from Japanese application JP2022-023981 filed on Feb. 18, 2022, the content of which is hereby incorporated by reference into this application.

### BACKGROUND OF THE INVENTION

### 1. Field of the Invention

The present disclosure relates to a user interface assembly of a vehicle, a drive system of a vehicle, and an electric assisted bicycle.

### 2. Description of the Related Art

Some electric assisted bicycles include a display that displays vehicle speed, cadence, remaining battery power, for example, and a cradle that supports the display, which is detachable from the cradle. When the display is attached to the cradle, a hook portion, formed on one of either the display or the cradle, is engaged with the other of the display or cradle, and thereby the display is locked to the cradle. In conventional bicycles, a portion operated by users in order to separate a display from a cradle (hereinafter, referred to as an operating portion) is integrally formed with the cradle. JP2013-525167A discloses an example of such a structure.

The operating portion for separating the display or the cradle has a leaf spring portion. When the user operates the operating portion, the leaf spring portion is deformed and the hook portion is disengaged. If the user operates the operating portion roughly or an external force unintentionally acts on the leaf spring, the operating portion may not move properly. In conventional structures, the operating portion is integrally formed with the cradle, and thus, the entire cradle needs to be replaced with a new one due to such a defect even if there is no trouble in other parts of the cradle (e.g., button, electric contacts, wires).

### SUMMARY OF THE INVENTION

(1) A user interface assembly of a vehicle disclosed in the present disclosure includes a user interface (UI) device, a cradle attached to the vehicle and supporting the UI device, and an operation member including an operating portion for a user to operate. A first engaging portion is formed on one of either the UI device or the cradle. The operation member includes a second engaging portion and is formed separately from and detachable from the other one of the UI device or the cradle. The second engaging portion is engaged with the first engaging portion to prevent the UI device from separating from the cradle and is movable with the operating portion so that the first engaging portion and the second engaging portion are disengaged from each other.

According to the user interface assembly, when an unintended external force acts on the operation member and causes the operating portion and the second engaging portion not to move properly, the cradle and the UI device can be used as is by replacing only the operation member with new one.

(2) In the user interface assembly described in (1), the one of the UI device or the cradle is the cradle, and the other one of the UI device or the cradle is the UI device. This enables a user to hold the UI device with one hand and operate the operating portion, thereby detaching the UI device from the cradle.

(3) In the user interface assembly described in (2), the UI device is slidable relative to the cradle in a first direction, and the operating portion of the operation member is movable in a second direction intersecting the first direction. This structure enables a user to hold the UI device with a finger pushing the operating portion in the second direction and more smoothly detach the UI device from the cradle.

(4) In the user interface assembly described in any one of (1) to (3), a plurality of contacts may be provided on the UI device or the cradle so as to establish an electrical connection between the UI device or the cradle. The operation member may be disposed so as to avoid the plurality of contacts. This eliminates the need to form the electrical contacts on the operation member, and thus simplifies the structure of the operation member.

(5) The user interface assembly described in any one of (1) to (4) may include a mechanism that allows the operation member to be detached from the other one of the UI device or the cradle. The mechanism may be exposed on an outer surface of the other one of the UI device or the cradle.

(6) In the user interface assembly described in (5), the mechanism may include a screw.

(7) In the user interface assembly described in (5), the mechanism may include a snap fit. This structure enables the operation member to be easily attached to the UI device or the cradle.

(8) In the user interface assembly described in any one of (1) to (7), the other one of the UI device or the cradle may include a first lateral side surface and a second lateral side surface, which is an opposite side surface of the first lateral side surface. The operating portion may be provided on the first lateral side surface and not on the second lateral side surface. This structure easily ensures a space inside the UI device or the cradle.

(9) In the user interface assembly described in (8), the first lateral side surface may face leftward of the vehicle when viewed in a travelling direction of the vehicle. This enables the user to easily recognize the position of the operation member when standing on the left side of the bicycle.

(10) In the user interface assembly described in any one of (1) to (9), the other one of the UI device or the cradle may be the UI device, the operation member may include an elastic portion supporting the operating portion and the second engaging portion, and the elastic portion may extend along a lateral side surface of the UI device. This structure easily secures a sufficiently long length of the elastic portion.

(11) In the user interface assembly described in any one of (1) to (10), the other one of the UI device or the cradle may include a first lateral side surface, of which an opening may be formed therein, and the operation member may be fitted into the opening. This structure serves to prevent the operation member from being noticeable. Further, this structure protects the operation member.

(12) In the user interface assembly described in any one of (1) to (11), the other one of the UI device or the cradle may be the UI device, the UI device may include a first lateral side surface, where an opening may be formed in the first lateral side surface, and the operating portion may be fitted into the opening. This serves to prevent the operation member from being noticeable. Further, when the UI device is carried, it is possible to protect the operation member and prevent an unintended external force from acting on the operation member.

(13) In the user interface assembly described in any one of (1) to (12), the operating portion of the operation member may be located in a front side or a rear side of the UI device.

(14) In the user interface assembly described in any one of (1) to (13), the UI device may include a display. The operating portion may be movable in a direction intersecting a surface of the display.

(15) A drive system proposed in the present disclosure includes the user interface assembly described in any one of (1) to (14), an electric motor, a control device that controls the electric motor, and a battery that supplies power to the electric motor.

(16) An electric assisted bicycle proposed in the present disclosure includes the drive system described in (15).

### BRIEF DESCRIPTION OF THE DRAWINGS

FIG. 1 is a block diagram showing a configuration of an electric assisted bicycle as an example of a vehicle proposed in the present disclosure;

FIG. 2A is a perspective view of an example of a user interface assembly;

FIG. 2B is a side view of the user interface assembly shown in FIG. 2A;

FIG. 3 is a perspective view of a UI device and a cradle shown in FIG. 2A separated from each other;

FIG. 4A is a perspective view of the UI device and an operation member separated from each other and showing their bottom surfaces;

FIG. 4B is a bottom view of the operation member and the UI device shown in FIG. 4A combined together;

FIG. 5 is a diagram illustrating a movement of the operation member when the UI device is attached to the cradle with the use of a cross section along the line V-V shown in FIG. 2B;

FIG. 6 is a diagram illustrating a movement of the operation member when the UI device is removed from the cradle with the use of the same cross section as FIG. 5;

FIG. 7 is a perspective view of another example of the user interface assembly;

FIG. 8A is a perspective view of the UI device and the operation member shown in FIG. 7 separated from each other and showing their bottom surfaces;

FIG. 8B is a perspective view of the UI device and the operation member shown in FIG. 7 combined together and showing their bottom surfaces;

FIG. 9 is a perspective view of the upper side of the operation member shown in FIG. 8A;

FIG. 10 is a diagram illustrating a movement of the operation member when the UI device shown in FIG. 7 is attached to the cradle;

FIG. 11 is a diagram illustrating a movement of the operation member when the UI device shown in FIG. 7 is removed from the cradle;

FIG. 12 is a diagram illustrating a movement of the operation member when the operation member is attached to the UI device shown in FIG. 7; and

FIG. 13 is a diagram illustrating a movement of the operation member when the operation member is removed from the UI device shown in FIG. 7.

### DETAILED DESCRIPTION OF THE INVENTION

In the following, a user interface (UI) assembly, a drive system having the UI assembly, and a vehicle having the drive system will be described.

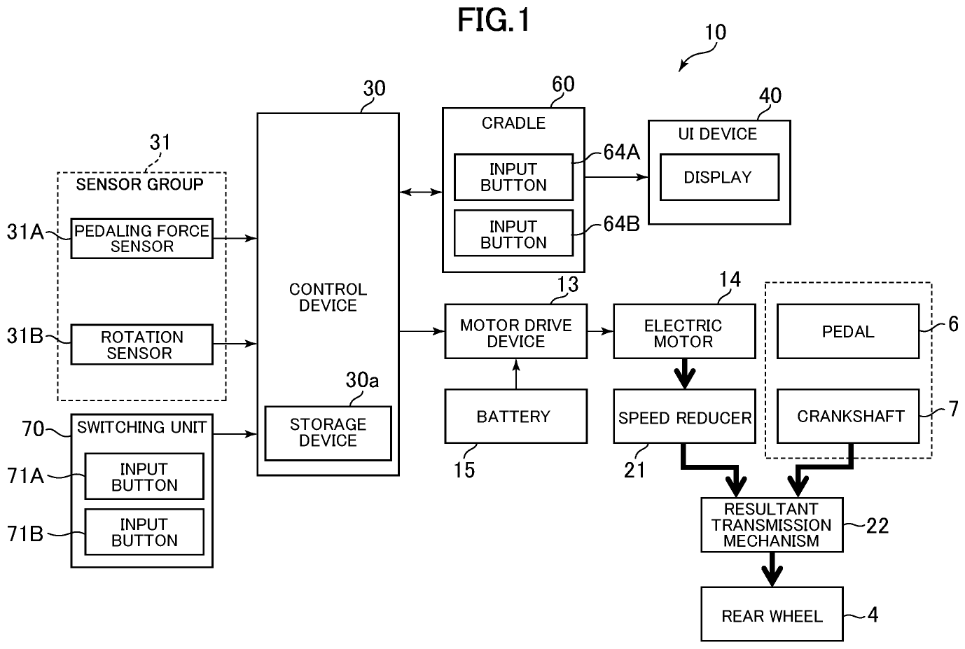

FIG. 1 is a block diagram showing a configuration of an electric assisted bicycle 10, which is an example of the vehicle proposed in the present disclosure. In FIG. 1, a thick solid line represents transmission of power, and a thin solid line represents an electric signal or current. Hereinafter, the electric assisted bicycle 10 will be simply referred to as a bicycle.

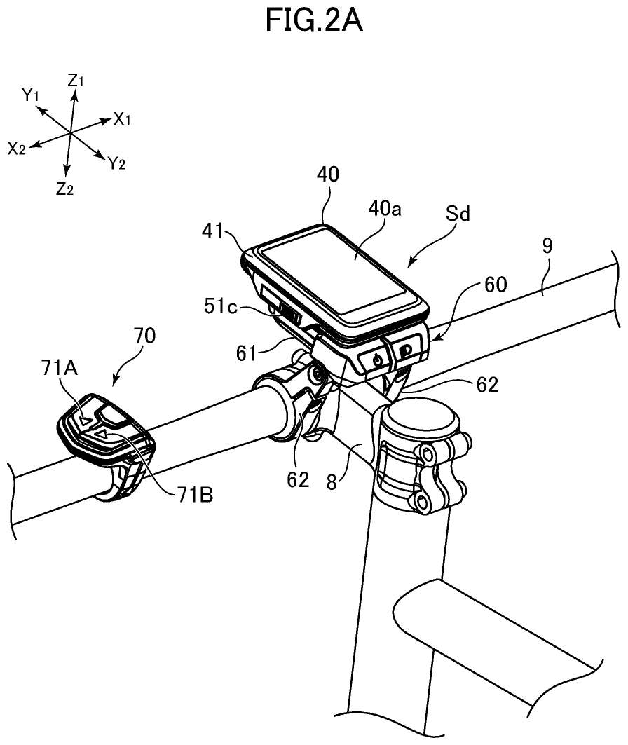

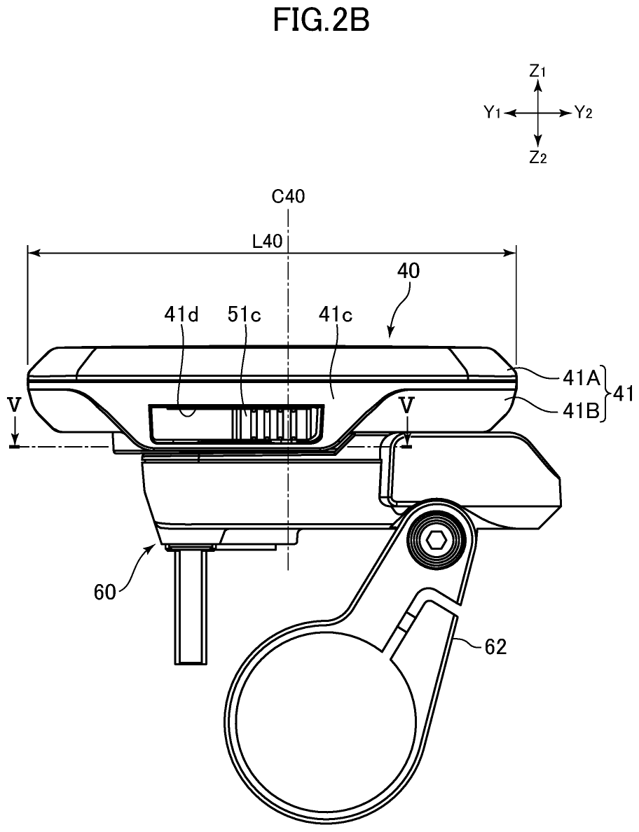

In the following, the directions indicated by Z1 and Z2 in FIG. 2A are referred to as upper and lower directions, the directions indicated by X1 and X2 are referred to as right and left directions, and the directions indicated by Y1 and Y2 are referred to as front and rear directions, respectively.

As shown in FIG. 1, the bicycle 10 includes an electric motor 14 and a speed reducer 21. The electric motor 14 is driven by the electric power supplied from a battery 15, and outputs an assist force (assist torque) for assisting a rider in driving a rear wheel 4 (stepping motion of pedals 6). The power (assist force) from the electric motor 14 is transmitted to a resultant transmission mechanism 22 through the speed reducer 21.

The bicycle 10 includes a crankshaft 7. The pedals 6 are attached to the left end and the right end of the crankshaft 7 via a crank arm. The force applied to the crankshaft 7 via the pedals 6 is transmitted to the resultant transmission mechanism 22.

The resultant transmission mechanism 22 may include a shaft, a rotation member (e.g., gear, sprocket, etc.) provided on the shaft, a power transmission member (e.g., chain, shaft, belt, etc.), for example. The resultant transmission mechanism 22 receives the force applied to the crankshaft 7 and the power from the electric motor 14. The power synthesized in the resultant transmission mechanism 22 is transmitted to the rear wheel 4. The power synthesized in the resultant transmission mechanism 22 may be input to the rear wheel 4 via a transmission mechanism capable of changing the gear ratio by the operation of the rider.

As shown in FIG. 1, the bicycle 10 includes a sensor group 31 including a plurality of sensors. The sensor group 31 includes, for example, a pedaling force sensor 31A for detecting the pedal force applied to the pedal 6 by the rider and a rotation sensor 31B for outputting a signal at a frequency corresponding to the vehicle speed, for example. Further, the bicycle 10 may include a pedal rotation sensor that outputs a signal at a frequency corresponding to the rotation speed of the pedal 6. The battery 15 may include an ammeter for detecting a current output from the battery 15.

### [Control Device]

As shown in FIG. 1, the drive system of the bicycle 10 includes a control device 30 that controls the electric motor 14. The control device 30 includes a storage device 30a that stores programs and maps related to the control of the electric motor 14. The storage device 30a includes a random access memory (RAM) and a read only memory (ROM), for example. The control device 30 includes one or more microprocessors that execute the programs.

The control device 30 calculates the speed of the bicycle or the travel distance of the bicycle 10 based on the signal of the rotation sensor 31B. The control device 30 detects the pedaling force based on the output of the pedaling force sensor 31A. The control device 30 controls the electric motor 14 based on the pedaling force and the speed. Specifically, the control device 30 calculates a command value of a current to be supplied to the electric motor 14 and outputs the command value to a motor drive device 13. The motor drive device 13 uses the battery 15 to supply the electric motor 14 with a current according to the command value. The control device 30 may have a strong mode in which the assist force is relatively large or a weak mode in which the assist force is relatively small as a control mode of the electric motor 14. A plurality of types of information regarding the state and control of the bicycle 10 are displayed on a display 40a to be described later.

The drive system of the bicycle 10 includes the control device 30, the electric motor 14, the battery 15, and a UI assembly Sd to be described later.

### User Interface Assembly According to Embodiment 1

As shown in FIG. 2A, the bicycle 10 has a handle 9 at a front portion thereof. The handle 9 is supported by a handle stem 8. The bicycle 10 has a user interface (UI) assembly Sd attached to the handle 9. The UI assembly Sd includes a UI device 40 and a cradle 60.

As shown in FIG. 2A, the bicycle 10 may also include a switching unit 70. The switching unit 70 may include, for example, input buttons 71A and 71B for switching the control modes (e.g., strong mode, weak mode). The switching unit 70 may also be attached to the handle 9. The switching unit 70 may be mounted at a position away from the UI assembly Sd.

### [UI Device]

As shown in FIG. 2A, the UI device 40 includes a display 40a. The display 40a may be a liquid crystal display device or an organic EL display device, for example. The display 40a may include a touch sensor for detecting a position of a finger of the user. The UI device 40 includes a housing 41 that contains the display 40a. The housings 41 may also contain batteries (e.g., button battery, coin battery) and a drive circuit of the display 40a.

For example, the display 40a may display the current time, cadence, remaining power of the battery 15 (remaining battery power), speed of the bicycle 10, travel distance (trip meter), total travel distance (odometer), and control mode.

The UI device 40 may be electrically connected to the control device 30 via the cradle 60. The UI device 40 may receive information displayed by the UI device 40, such as a traveling distance and cadence, from the control device 30. For example, the control device 30 may calculate the remaining battery power based on the current supplied from the battery 15 to the electric motor 14, or calculate the speed of the bicycle based on the output signal of the rotation sensor 31B. The control device 30 may then transmit the calculated information to the UI device 40. Alternatively, the UI device 40 may calculate the information (value) to be displayed. For example, the UI device 40 may include a timer. The current time displayed by the display 40a may be calculated based on the output of the timer.

The UI device 40 may have one or more light-emitting units (e.g., light emitting diode) that represent the status of the bicycle 10 (e.g., remaining battery power) in place of or in addition to the display 40a. Further, the UI device 40 may include a button for inputting the user's instruction to the control device 30 in place of or in addition to the display 40a.

### [Cradle]

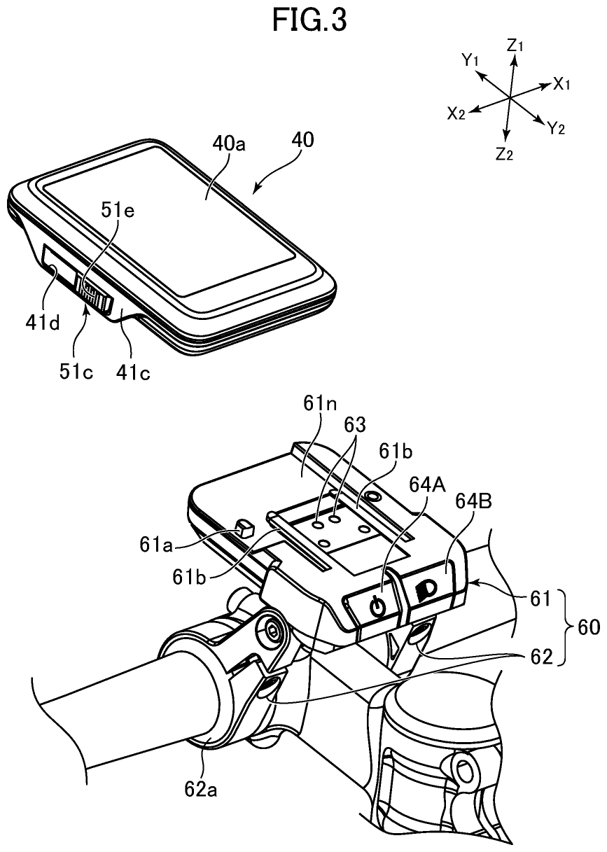

As shown in FIG. 2A, the cradle 60 is supported by the handle 9. The cradle 60 may be located at the center of the handle 9 in the left-right direction. In use, the UI device 40 is supported by the cradle 60. As shown in FIG. 3, the cradle 60 may include a stage 61, to which the UI device 40 is attached, and a clamp portion 62 extending from the stage 61, for example. The upper end of the clamp portion 62 is connected to each of the right portion and the left portion of the stage 61, for example. The clamp portion 62 may extend downward from the stage 61. The lower end of the clamp portion 62 may include a holder part 62a for holding the handle 9.

The structure of the cradle 60 is not limited to the example described herein. For example, the clamp portion 62 may extend from the center of the stage 61 in the left-right direction toward the handle 9, or extend from only one of the right portion and the left portion of the stage 61 toward the handle 9.

The stage 61 may include a circuit board or an electric wire. Further, a connector may be provided to the stage 61 so as to electrically connect to another electronic device (e.g., portable terminal of the user). The stage 61 includes a housing 61n for accommodating the circuit board, for example. The housing 61n and the clamp portion 62 may be integrally formed, or may be fixed to each other by a fastener, such as a screw as shown in FIG. 3. The housing 61n and the clamp portion 62 may be made of resin or metallic material, for example.

As shown in FIG. 3, the cradle 60 may include input buttons 64A and 64B. The input buttons 64A and 64B may be disposed on the rear surface of the stage 61, for example. The input buttons 64A and 64B may be a power button of the control device 30 or a button for turning on/off a headlamp (not shown), for example.

### [Attachment and Detachment Structure]

The UI device 40 is detachable from the cradle 60 (more specifically, stage 61). As shown in FIG. 3, the UI device 40 may be slid forward from the cradle 60 to be detached.

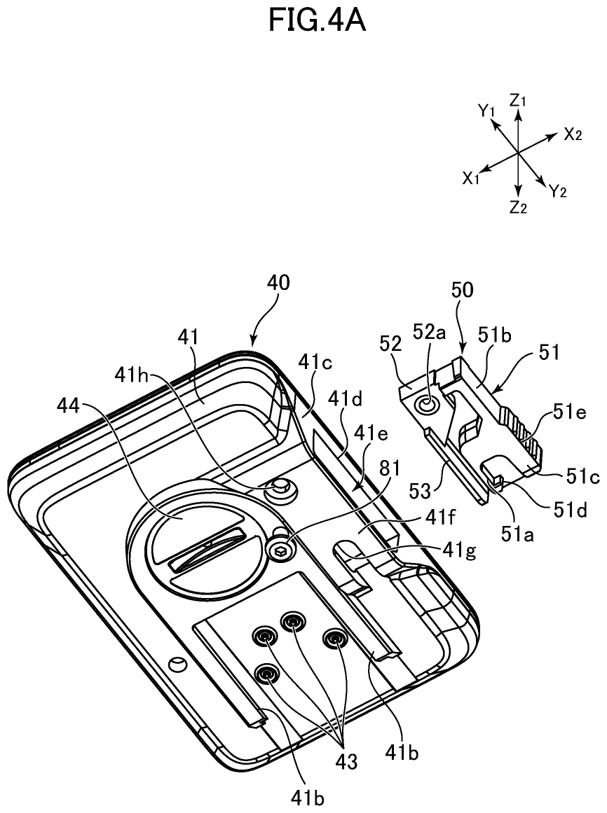

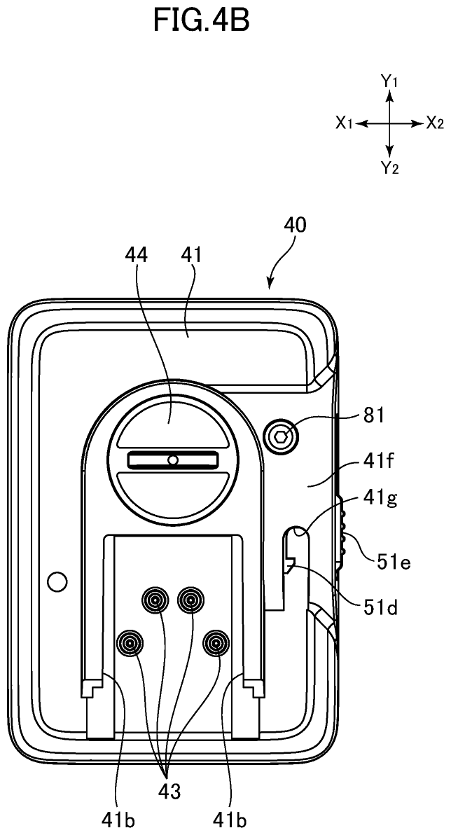

As shown in FIG. 3, the stage 61 may include guide portions 61b extending in the front-rear direction. As shown in FIG. 4A, the housing 41 of the UI device 40 may include guided portions 41b extending in the front-rear direction. The guided portions 41b are slidable along the guide portions 61b while being engaged with the guide portions 61b, and are restricted from being separated upward from the guide portions 61b.

As shown in FIG. 3, the stage 61 may include two guide portions 61b that are separated from each other in the left-right direction. The two guide portions 61b may have convex portions protruding upward from the upper surface of the stage 61 and protruding outward in the left-right direction, for example. As shown in FIG. 4A, the two guided portions 41b that are apart from each other in the left-right direction may be formed on the lower surface of the housing 41. The two guide portions 61b are respectively fitted inside the two guided portions 41b. The grooves may be formed inside the two guided portion 41b so that the convex portions (protruding outward in the left-right direction) formed on the guide portions 61b are engaged. Such engagement guides the guided portions 41b in the front-rear direction and prevents the guided portions 41b from separating from the guide portions 61b upward. In contrast to the example described herein, grooves may be formed as the guide portions 61b, and convex portions may be formed as the guided portions 41b.

The UI device 40 may not be detached in the forward direction. The UI device 40 may be detachable rearward, rightward, or leftward from the stage 61. As yet another example, the UI device 40 may be rotatable with respect to the stage 61 (rotatable about the centerline perpendicular to the upper surface of the stage 61). The UI device 40 may be detached upward from the stage 61 by being rotated with respect to the stage 61.

### [Engaging Portion and Operation Member]

As shown in FIG. 3, a first engaging portion 61a is formed in the stage 61. As shown in FIG. 4A, the UI assembly Sd includes an operation member 50. The operation member 50 is formed separately from the UI device 40 and is detachable from the UI device 40. The operation member 50 includes a second engaging portion 51a that engages with the first engaging portion 61a. The engaging portions 61a and 51a are engaged with each other, whereby the UI device 40 is fixed to the cradle 60. That is, when the engaging portion 61a and 51a are engaged with each other, the UI device 40 is prevented from being separated from the cradle 60 in the forward direction. Further, when the engaging portions 61a and 51a are disengaged from each other, the UI device 40 is allowed to be separated from the cradle 60. The first engaging portion 61a is fixed on the stage 61.

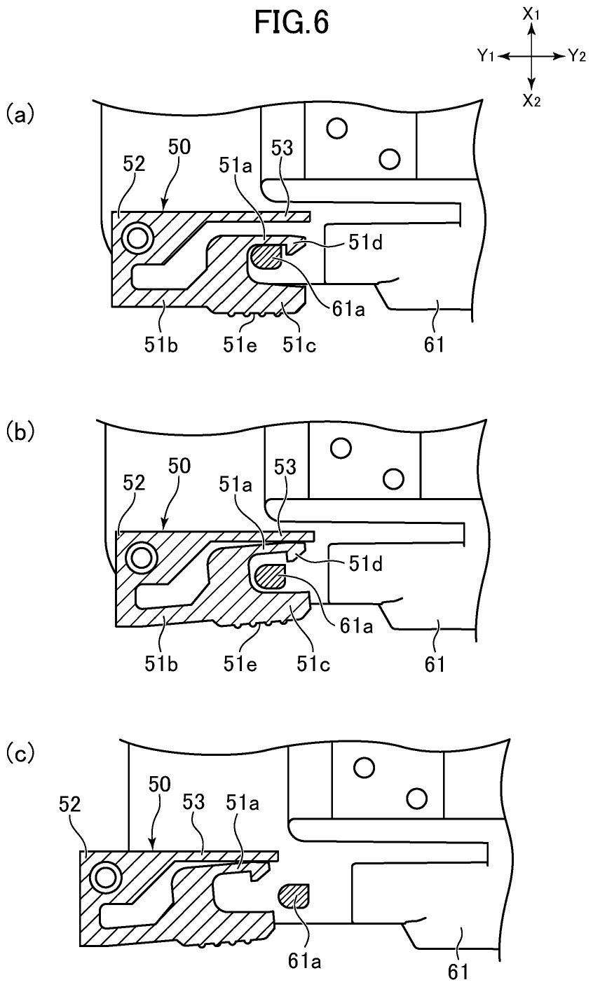

As shown in FIG. 4A, the operation member 50 may include a movable portion 51. The movable portion 51 includes an elastic portion 51b having a leaf spring, for example, and may be connected to a base 52 of the operation member 50 via the elastic portion 51b. An operating portion 51c for the user to operate and the second engaging portion 51a may be formed in the movable portion 51. The operating portion 51c is movable together with the second engaging portion 51a so as to disengage the first engaging portion 61a and the second engaging portion 51a from each other (see FIG. 6).

As described above, the second engaging portion 51a is formed in the operation member 50 that is formed separately from the UI device 40. As such, when an unintended external force acts on the elastic portion 51b and causes a malfunction such as the operating member 50 not functioning properly, for example, the UI device 40 or the cradle 60 can be used as is by replacing only the operation member 50 with a new one.

The operation member 50 is attached to the UI device 40 instead of the cradle 60. As such, the user can smoothly remove the UI device 40 from the cradle 60. For example, while holding the UI device 40 with the right hand, the user operates the operating portion 51c with the right hand to disengage the engaging portion 51a from the engaging portion 61a, thereby removing the UI device 40 from the cradle 60. At this time, the user can freely use the left hand.

As shown in FIG. 4A, the elastic portion 51b may extend rearwardly from the base 52. The operating portion 51c and the second engaging portion 51a may be formed at the rear portion of the elastic portion 51b. The operating portion 51c and the second engaging portion 51a are separated from each other in the left-right direction. In other words, a recessed portion that is open rearwardly is formed between them. As will be described later, when the UI device 40 is attached to the cradle 60, the first engaging portion 61a of the cradle 60 is disposed between the operating portion 51c and the second engaging portion 51a. The second engaging portion 51a is located inside the operating portion 51c (closer to the center of the UI device 40). In the illustrated example, the second engaging portion 51a is located rightward of the operating portion 51c. The second engaging portion 51a may have a hook portion 51d at its rear end. The hook portion 51d protrudes toward the operating portion 51c.

The elastic portion 51b may extend along the edge of the display 40a (see FIG. 3). This structure easily secures the length of the elastic portion 51b. In the illustrated example, the elastic portion 51b extends along the left edge of the display 40a. The elastic deformation of the elastic portion 51b allows the operating portion 51c and the second engaging portion 51a to move in the direction perpendicular to the edge of the display 40a, specifically, in the left-right direction.

As shown in FIG. 3, the operating portion 51c has an exposed surface 51e (the left surface in FIG. 3) exposed on the outer surface of the UI device 40. When the user pushes the exposed surface 51e, the operating portion 51c and the second engaging portion 51a move rightward due to the elastic deformation of the elastic portion 51b (see FIG. 6). When the pushing force of operating portion 51c is released, the operating portion 51c and the second engaging portion 51a return to the starting position. The exposed surface 51e may be processed with an uneven pattern, for example, so as to serve as a slip stopper for fingers.

The shape of the operation member 50 is not limited to the illustrated example. For example, the elastic portion 51b may extend forward from the base 52. In this case, the second engaging portion 51a and the operating portion 51c may be formed at the front portion of the elastic portion 51b.

### [Movement of Operation Member in Attachment and Detachment of UI Device]

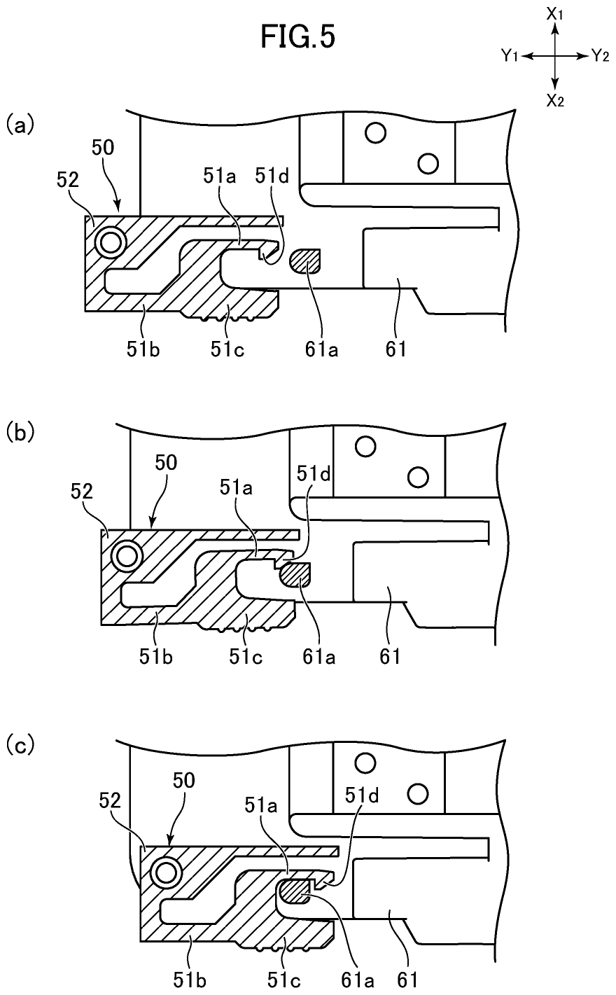

FIG. 5 is a diagram showing the movement of the operation member 50 when the UI device 40 is attached to the cradle 60.

As shown in FIG. 5(a), when the UI device 40 is brought closer to the cradle 60, the operation member 50 moves rearward along the stage 61. The left and right guided portions 41b are then fitted to the guide portions 61b, and the UI device 40 is moved along the guide portions 61b. As shown in FIG. 5(b), the hook portion 51d formed at the distal end of the second engaging portion 51a interferes with the first engaging portion 61a, and the elastic portion 51b is elastically deformed. The first engaging portion 61a is fixed to the stage 61, and the position of the first engaging portion 61a does not change. When the elastic portion 51b is elastically deformed, the second engaging portion 51a is moved and the hook portion 51d passes over the first engaging portion 61a. An inclined surface that is inclined with respect to the attaching direction of the UI device 40 and causes such elastic deformation is formed in each of the rear side of the hook portion 51d and the front side of the first engaging portion 61a.

As shown in FIG. 5(c), when the hook portion 51d passes over the first engaging portion 61a, the second engaging portion 51a engages with the first engaging portion 61a. The front surface of the hook portion 51d (the surface facing the first engaging portion 61a in (c)) and the rear surface of the first engaging portion 61a (the surface facing the hook portion 51d in (c)) are substantially perpendicular to the attaching/detaching direction of the UI device 40 (front-rear direction in FIG. 5). As such, the first engaging portion 61a prevents the UI device 40 and the operation member 50 from moving forward with respect to the cradle 60.

FIG. 6 is a diagram showing the movement of the operation member 50 when the UI device 40 is detached from the cradle 60.

As shown in FIG. 6(a) and FIG. 6(b), the user pushes the exposed surface 51e of the operation member 50 (the left surface exposed on the left side surface 41c of the housing 41). The elastic portion 51b is then elastically deformed, and the operating portion 51c is moved rightward together with the second engaging portion 51a. In this manner, as shown in FIG. 6(c), the hook portion 51d and the first engaging portion 61a are disengaged from each other, and the UI device 40 and the operation member 50 are allowed to move forward.

As described above, the UI device 40 is slidable forward when removed from the cradle 60. The operating portion 51c of the operation member 50 can be pushed in the direction substantially perpendicular to this sliding direction. In the illustrated example, the operating portion 51c is movable rightward about the base of the elastic portion 51b. This enables a finger (e.g., thumb) pushing the operating portion 51c to hold the UI device 40, and the UI device 40 can thereby be smoothly removed from the cradle 60.

As shown in FIG. 2B, the operating portion 51c may intersect a line C40 passing through the center of the UI device in the front-rear direction (the center of the length L40). This allows the user to put the finger (e.g., thumb) smoothly on the operating portion 51c when the user holds the UI device 40. As shown in FIG. 2B, the operating portion 51c may be offset forward with respect to the line C40.

As shown in FIG. 4A, the operation member 50 may include a stopper portion 53 extending rearward from the base 52. The stopper portion 53 is located inward with respect to the movable portion 51 (closer to the center of the UI device 40). As shown in FIG. 6(b) and FIG. 6(c), when the operating portion 51c is pushed and the operating portion 51c and the second engaging portion 51a are moved inward, the stopper portion 53 hits the second engaging portion 51a to prevent excessive deformation of the movable portion 51.

### [Attachment Structure of Operation Member]

As shown in FIG. 4A, the UI device 40 has an opening 41d on a lateral side surface 41c thereof. The opening 41d is formed on a left side surface 41c of the housing 41, for example. The operation member 50 is fitted to the opening 41d and attached to the UI device 40. The UI device 40 includes an accommodation chamber 41e for accommodating the operation member 50. When the operation member 50 is disposed in the accommodation chamber 41e, the left surface of the operating portion 51c (the exposed surface 51e described above) is exposed from the opening 41d.

Such structure in which the operation member 50 is disposed in the accommodation chamber 41e serves to reduce the area where the operation member 50 is exposed. As a result, the housing 41 can protect the operation member 50. This prevents an unintended external force from acting on the operation member 50 when the user carries the operation member 50 in a bag, for example.

As shown in FIGS. 4A and 4B, the housing 41 may include a protective portion 41f forming the lower wall of the accommodation chamber 41e. The protective portion 41f covers the lower side of the operation member 50. More specifically, the protective portion 41f covers the lower side of the movable portion 51 of the operation member 50. This effectively prevents an unintended external force from acting on the movable portion 51. Not only the lower side but also the upper side of the operation member 50 is covered with a part of the UI device 40 (e.g., a part in which the display 40a is contained).

The protective portion 41f may be integrally formed of resin with the other part of the housing 41. For example, the housing 41 may include an upper housing 41A (see FIG. 2B) and a lower housing 41B (see FIG. 2B) that are vertically combined. An accommodation chamber may be formed therebetween so as to accommodate the display 40a and the circuit board, for example. In this case, the protective portion 41f may be integrally formed with the lower housing 41B. Alternatively, the protective portion 41f may be formed separately from other portions of the housing 41 and attached to the other part of the housing 41 with fasteners, such as screws and adhesive.

As shown in FIG. 4B, a recessed portion 41g may be formed in the protective portion 41f. The recessed portion 41g is open toward the rear side (i.e., toward the attaching direction of the UI device 40 to the cradle 60). The first engaging portion 61a formed in the cradle 60 enters the recessed portion 41g. As shown in FIG. 4B, when viewed from the bottom of the housing 41, the hook portion 51d of the second engaging portion 51a is exposed inside the recessed portion 41g. The elastic portion 51b and the operating portion 51c are covered with the protective portion 41f.

As shown in FIG. 4A, the operation member 50 includes a base 52. The movable portion 51 extends from the base 52. A screw hole 52a is formed in the base 52. An attachment hole 41h is formed in the protective portion 41f of the housing 41. When the operation member 50 is accommodated in the accommodation chamber 41e of the UI device 40, a screw 81 may be fitted to the screw hole 52a and the attachment hole 41h in the direction perpendicular to the fitting direction of the operation member 50 to the opening 41d. In the illustrated example, the screw 81 can be inserted into the screw hole 52a and the attachment hole 41h from the lower side of the housing 41. This attachment structure serves to prevent the screw 81 from being noticeable. Unlike the illustrated example, the screw 81 may be inserted into a hole formed in the lateral side surface 41c of the housing 41 or a hole formed in the upper surface of the housing 41 so as to fix the operation member 50 to the UI device 40.

When the screw 81 is removed, the operation member 50 can be removed from the UI device 40. As shown in FIG. 4B, the screw 81 is exposed on the outer surface of the UI device 40 (lower surface of the protective portion 41f). As such, the user uses a tool (e.g., hexagonal driver, Phillips screwdriver), thereby accessing the screw 81 from the outside of the UI device 40. That is, the user can access the screw 81 and remove the operation member 50 without opening the housing 41.

The mechanism of attaching the operation member 50 to the housing 41 is not limited to using the screw 81 as described herein. For example, as described below, the operation member 50 may be attached to the housing 41 by a snap fit. To release the snap fit, a tool may be used from outside the housing 41 to access the snap fit.

As described above, it is possible to use a tool to access the mechanism for attaching the operation member 50 to the UI device 40, that is, the screw 81 and the snap fit, from the outside. The use of the tool enables the operation member 50 to be detached from the UI device 40. On the other hand, no tool is required to attach or detach the UI device 40 to or from the cradle 60. The user simply slides the UI device 40 along the guide portions 61b, thereby attaching the UI device 40 to the cradle 60. Further, the user simply operates the operating portion 51c of the operation member 50 to slide the UI device 40 forward, thereby removing the UI device 40 from the cradle 60.

As shown in FIG. 4A and FIG. 4B, the elastic portion 51b of the operation member 50 extends along the lateral side surface 41c of the UI device 40. The lateral side surface 41c is a plane along the edge of the display 40a. In the illustrated example, the elastic portion 51b is disposed along the left side surface 41c from which the exposed surface 51e is exposed. Such an arrangement of the elastic portion 51b facilitates providing the appropriate length of the elastic portion 51b. Specifically, the width of the UI device 40 in the front-rear direction (length L40 in FIG. 2B) is larger than the width of the UI device 40 in the left-right direction. The elastic portion 51b is disposed along the side surface 41c that defines the width of the UI device 40 in the front-rear direction. This makes it easier to ensure the appropriate length of the elastic portion 51b.

Unlike the illustrated examples, in a case where the elastic portion 51b is extended from the lateral side surface 41c of the UI device 40 toward the center of the UI device 40 (the center of the display 40a), extending the elastic portion 51b serves to reduce the space within the housing 41. In contrast, in the examples shown in FIGS. 4A and 4B, the elastic portion 51b is disposed along the lateral side surface 41c of the UI device 40, and this prevents the space within the housing 41 from being reduced.

As shown in FIG. 3, a plurality of contacts 63 are provided on the upper surface of the stage 61. In the example shown in FIG. 3, four contacts 63 are provided. As shown in FIG. 4A, the lower surface of the UI device 40 also has a plurality of contacts 43. The positions of the contacts 43 respectively correspond to the positions of the contacts 63. When the UI device 40 is attached to the cradle 60, the contacts 43 are electrically connected to the contacts 63, respectively. An electric wire for electrically connecting the control device 30 and the UI device 40 is provided through the cradle 60. The terminals of the wire may have the contacts 63. For example, the contacts 43 and 63 may include contacts for transmitting and receiving signals (information displayed on the display 40a) and contacts for supplying power from the battery 15 to the UI device 40.

As shown in FIG. 3, the contacts 63 may be formed between the left and right guide portions 61b. As shown in FIG. 4A, the contacts 43 may be formed between the left and right guided portions 41b. As described above, the guide portions 61b and the guided portions 41b are engaged with each other so as to prevent the UI device 40 from vertically separating from the stage 61. As such, the positions of the contacts 43 and 63 described above can improve the connection stability between the contacts 43 and the contacts 63.

As shown in FIG. 4A, the UI device 40 may have a lid 44 in front of the contacts 43. The lid 44 may be used for a battery included in the UI device 40, for example.

The operation member 50 may be disposed so as to avoid the positions of the contacts 43. This allows the contact 43 of the UI device 40 and the contact 63 of the cradle 60 to be in direct contact with each other, thereby eliminating the need to form an electric contact on the operation member 50. As a result, the structure of the operation member 50 can be simplified.

In the illustrated example, the operation member 50 is disposed on the left side of the contacts 43. That is, the accommodation chamber 41e is formed on the left side of the contacts 43. The operation member 50 is not provided in the right part of the UI device 40. In other words, the operation member 50 is disposed only on the left side of the contacts 43, and not disposed on the right side. This structure easily ensures a space in the housing 41 compared to, for example, a structure in which the operation members 50 are disposed on the left side and the right side of the housing 41. As a result, the layout of components in the housing 41 can be made more flexible.

The operating portion 51c of the operation member 50 is provided on the left side surface 41c of the housing 41. In many cases, a user stands on the left side of the bicycle 10 when getting off the bicycle 10. As such, if the operating portion 51c is placed on the left side surface 41c of the UI device 40, the user can easily recognize the operating portion 51c. Further, when operating the operating portion 51c with the right hand, the user can easily press the operating portion 51c with the thumb.

The arrangement of the operation member 50 in the UI device is not limited to the illustrated example. For example, the operation member 50 may be provided on the front surface of the UI device 40. In this case, the operating portion 51c and the second engaging portion 51a may be movable in the front-rear direction by elastic deformation of the elastic portion 51b. When the front surface (exposed surface) of the operating portion 51c is pushed, the second engaging portion 51a and the first engaging portion 61a may be disengaged from each other. In this case, the UI device 40 may be detachable from the stage 61 leftward or rightward.

As yet another example, the operation member 50 may be provided on the right side surface of the UI device 40. In this case, the operating portion 51c and the second engaging portion 51a may be movable in the left-right direction by elastic deformation of the elastic portion 51b.

As yet another example, the UI assembly Sb may have the operation members 50 on both the left side surface 41c and the right side surface of the UI device 40. In this case, the stage 61 may have a left first engaging portion 61a and right first engaging portion 61a respectively engaged with the left second engaging portion 51a and the right second engaging portion 51a. When the operating portions 51c of the left and right operation members 50 are pushed inward, the second engaging portion 51a and the first engaging portion 61a may be disengaged from each other.

As yet another example, the operation member 50 may be attached to the UI device 40 and slidable relative to the UI device 40. For example, the operation member 50 may be slidable in the front-rear direction relative to the UI device 40. The operation member 50 may be arranged such that the operating portion 51c is exposed on the left side 41c of the UI device 40. In this case, for example, the operation member 50 may be slid forward, whereby the second engaging portion of the operation member 50 and the first engaging portion 61a formed in the cradle 60 may be disengaged from each other. The UI device 40 may be detachable leftward from the cradle 60.

### User Interface Assembly According to Embodiment 2

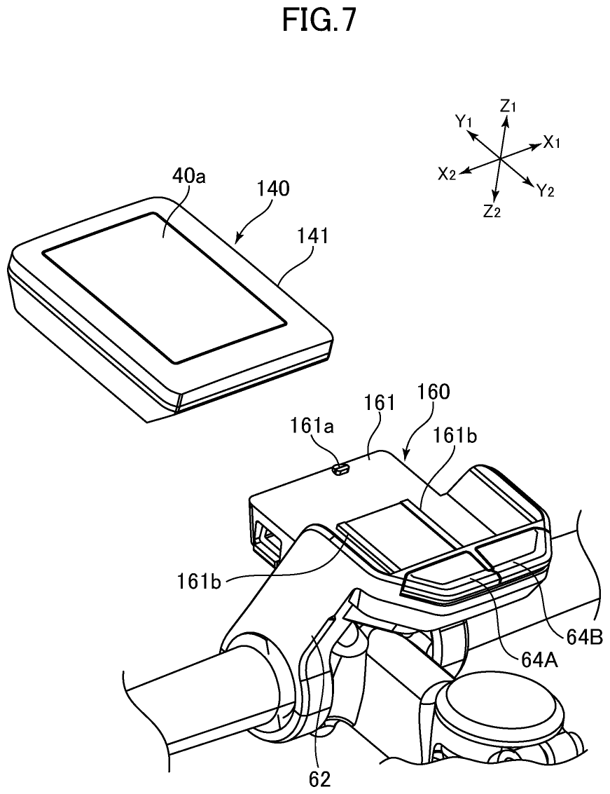

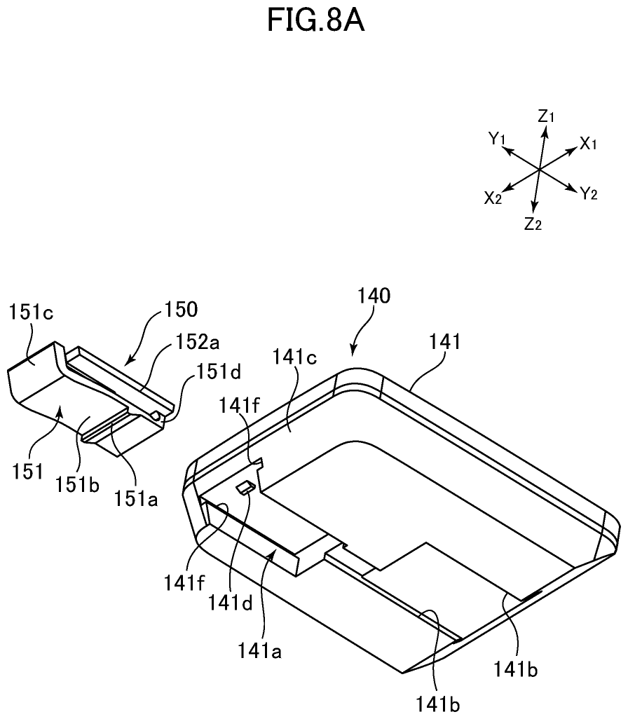

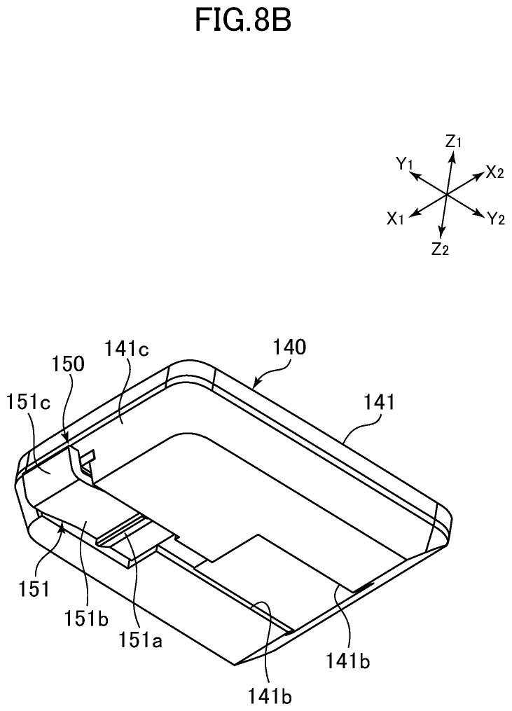

FIGS. 7 to 13 are diagrams illustrating another example of the UI assembly according to the present disclosure. In these diagrams, the UI assembly Sd includes a UI device 140 and a cradle 160. The UI assembly also includes an operation member 150 (see FIGS. 8A and 8B). In the following, the differences from the UI device 40, the cradle 60, and the operation member 50 described above will be mainly described. The matters that are not explained as to the examples shown in FIG. 7, for example, may be the same as the examples described with respect to FIGS. 2A to 6.

### [Attachment and Detachment of UI Device]

The UI device 140 may be attached to and detached from the cradle 160 (more specifically, stage 161). As shown in FIG. 7, the UI device 140 may be detachable forwardly from the cradle 160. The stage 161 may include guide portions 161b extending in the front-rear direction. As shown in FIG. 8A, the UI device 140 may include guided portions 141b extending in the front-rear direction. The guided portions 141b are slidable along the guide portions 161b while being engaged with the guide portions 161b, and are restricted from being separated upward from the guide portions 161b.

As shown in FIGS. 8A and 8B, the operation member 150 is formed separately from the UI device 140 and attached to the front side of the UI device 140. Unlike the operation member 50 described above, the operation member 150 is attached to the UI device 140 by a snap fit. The mechanism of attaching the operation member 150 to the UI device 140 will be described in detail later.

As shown in FIG. 8A, the operation member 150 has a lower movable portion 151. The lower movable portion 151 has an elastic portion 151b extending forward from the base 151d. The elastic portion 151b is elastically deformable around the base 151d in the vertical direction. The operating portion 151c is formed at the foremost portion of the lower movable portion 151 and bent upward with respect to the elastic portion 151b. The operating portion 151c is exposed on the front side surface 141c of the UI device 140. The elastic deformation of the elastic portion 151b allows the operating portion 151c to move in the vertical direction, that is, in a direction intersecting the surface of the display 40a.

As shown in FIG. 7, a first engaging portion 161a is formed in the stage 161 of the cradle 160. As shown in FIG. 8A, a second engaging portion 151a is formed in the operation member 150. The second engaging portion 151a is formed on the lower surface of the elastic portion 151b.

### [Movement of Operation Member in Attachment and Detachment of UI Device]

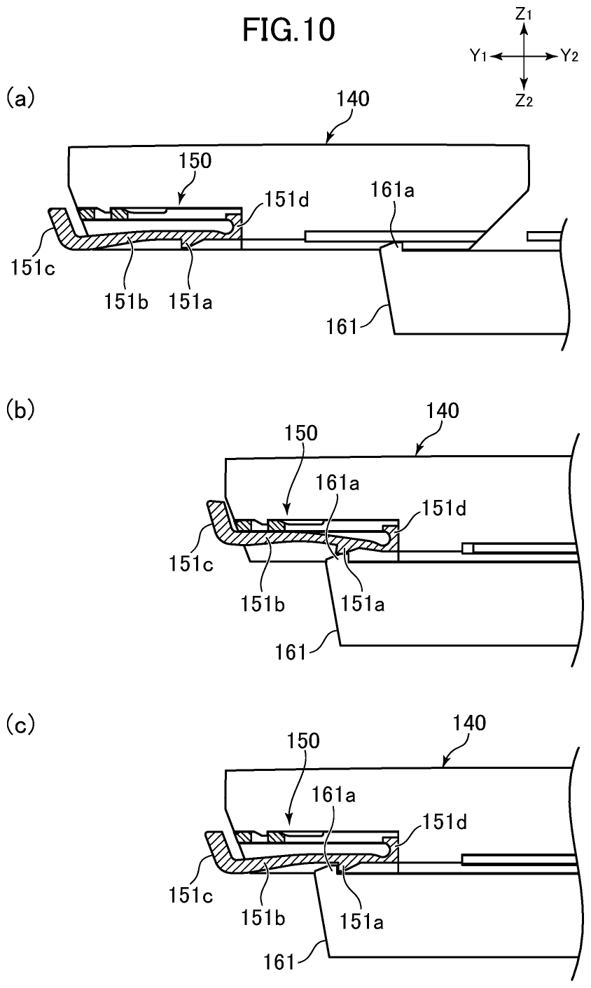

FIG. 10 is a diagram showing the movement of the operation member 150 when the UI device 140 is attached to the cradle 160.

As shown in FIG. 10(a), when the UI device 140 is brought closer to the cradle 160, the operation member 150 moves rearward along the stage 161. Subsequently, as shown in FIG. 10(b), the second engaging portion 151a interferes with the first engaging portion 161a, and the elastic portion 151b elastically deforms around the base 151d and lifts up overall. When the elastic portion 151b is elastically deformed in this manner, the second engaging portion 151a passes over the first engaging portion 161a. An inclined surface that is inclined with respect to the mounting direction of the UI device 140 and causes such elastic deformation is formed in each of the second engaging portion 151a and the first engaging portion 161a.

As shown in FIG. 10(c), when the second engaging portion 151a passes over the first engaging portion 161a, the second engaging portion 151a engages with the first engaging portion 161a. The front surface of the second engaging portion 151a (the surface facing the first engaging portion 161a in (c)) and the rear surface of the first engaging portion 161a (the surface facing the second engaging portion 151a in (c)) are substantially perpendicular to the attaching/detaching direction of the UI device 140, that is, the front-rear direction. As such, the first engaging portion 161a prevents the UI device 140 and the operation member 150 from moving forward with respect to the cradle 160.

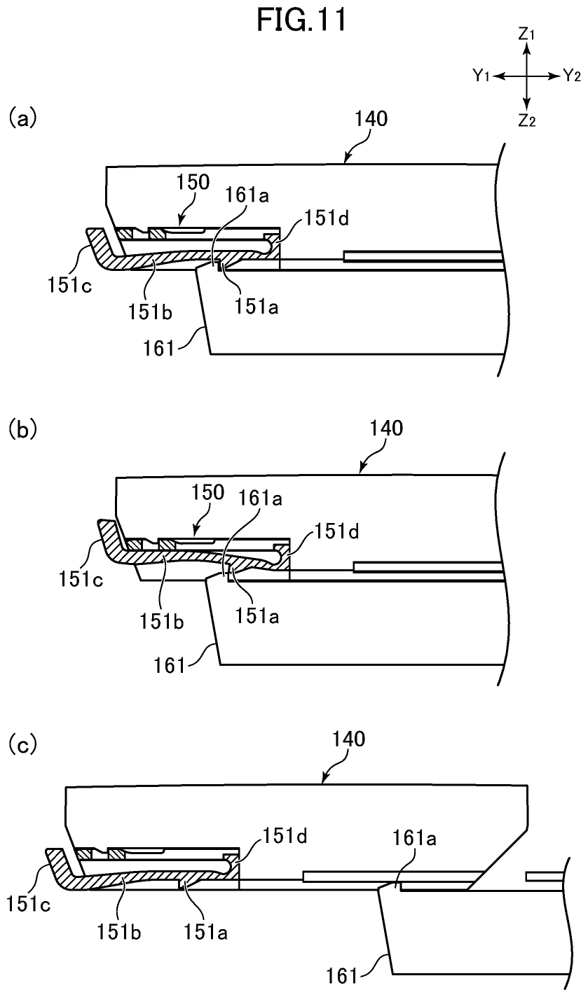

FIG. 11 is a diagram showing the movement of the operation member 150 when the UI device 140 is detached from the cradle 160.

As shown in FIG. 11(a) and FIG. 11(b), the user pushes the operating portion 151c of the operation member 150 upward. This elastically deforms the elastic portion 151b, and the second engaging portion 151a is pulled upward. As shown in FIG. 11(c), the second engaging portion 151a and the first engaging portion 161a are thus disengaged from each other, and the operation member 150 is allowed to move forward.

In this way, the operating portion 151c of the operation member 150 can be pushed in a direction substantially perpendicular to the sliding direction of the UI device 140. In the illustrated example, the operating portion 151c is movable upward about the base of the elastic portion 151b. This enables the finger pushing the operating portion 151c to hold the UI device 140, and the UI device 140 can thereby be smoothly removed from the cradle 160. For example, when sliding the UI device 140 forward, the user can hold the UI device 140 with the thumb, the middle finger, and the index finger. At this time, the user can push the operating portion 151c with the index finger.

Unlike the example shown in FIG. 7, for example, the lower movable portion 151 of the operation member 150 disposed on the front surface of the UI device 140 may be movable in the front-rear direction. When the user pushes the front surface (exposed surface) of the operating portion 151c, the second engaging portion 151a and the first engaging portion 161a formed in the stage 161 may be disengaged from each other. In this case, the UI device 140 may be detachable from the cradle 160 leftward or rightward.

### [Operation Member]

Similarly to the operation member 50 shown in FIG. 4A, for example, the operation member 150 is also formed separately from the UI device 140 and detachable from the UI device 140. The operation member 150 is attached to the UI device 140 by a snap fit.

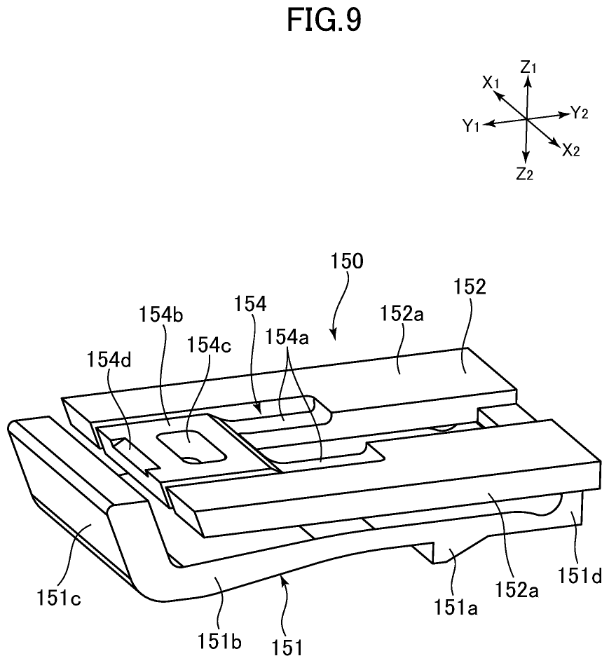

Specifically, as shown in FIG. 8A, a third engaging portion 141d is formed on the lower surface of the UI device 140 (lower surface of the housing 141). The third engaging portion 141d may be a convex portion (hook portion) protruding downward, for example. An accommodating recessed portion 141a, into which the operation member 150 is fitted, may be formed on the lower surface of the UI device 140. The third engaging portion 141d may be formed on the inner surface (surface facing downward) of the accommodating recessed portion 141a. As shown in FIG. 9, the operation member 150 has an upper movable portion 154 to be engaged with the third engaging portion 141d.

The upper movable portion 154 is located above the elastic portion 151b having the second engaging portion 151a that engages with the cradle 160. The upper movable portion 154 may include an elastic portion 154a extending forward from the fixed portion 152 and a fourth engaging portion 154b formed at the front end of the elastic portion 154a. The fourth engaging portion 154b is movable up and down by elastic deformation of the elastic portion 154a. An engagement hole 154c may be formed in the fourth engaging portion 154b. The engagement hole 154c is engaged with the third engaging portion 141d so that the operation member 150 is attached to the UI device 140.

In contrast to the illustrated example, a recessed portion may be formed on the lower surface of the UI device 140 as the third engaging portion 141d. Further, a convex portion that fits into the third engaging portion 141d may be formed in the operation member 150 as the fourth engaging portion 154b.

As shown in FIG. 8A, the lower surface of the UI device 140 (lower surface of the housing 141) has guide portions 141f extending in the front-rear direction. In the example shown in FIG. 8A, grooves as the guide portions 141f are formed on the right inner surface and the left inner surface of the accommodating recessed portion 141a. The fixed portion 152 of the operation member 150 includes guided portions 152a. In the illustrated example, the right edge and the left edge of the fixed portion 152 respectively project rightward and leftward, and function as the guided portions 152a. The guided portions 152a are fitted to the guide portions 141f and movable in the front-rear direction. This restricts the operation member 150 to moving in the front-rear direction with respect to the UI device 140.

In contrast to the illustrated example, grooves extending in the front-rear direction may be formed on the left and right side surfaces of the operation member 150 as the guided portions 152a. The UI device 140 may include convex portions fitted to the guided portions 152a as the guide portions 141f.

### [Attachment and Detachment of Operation Member]

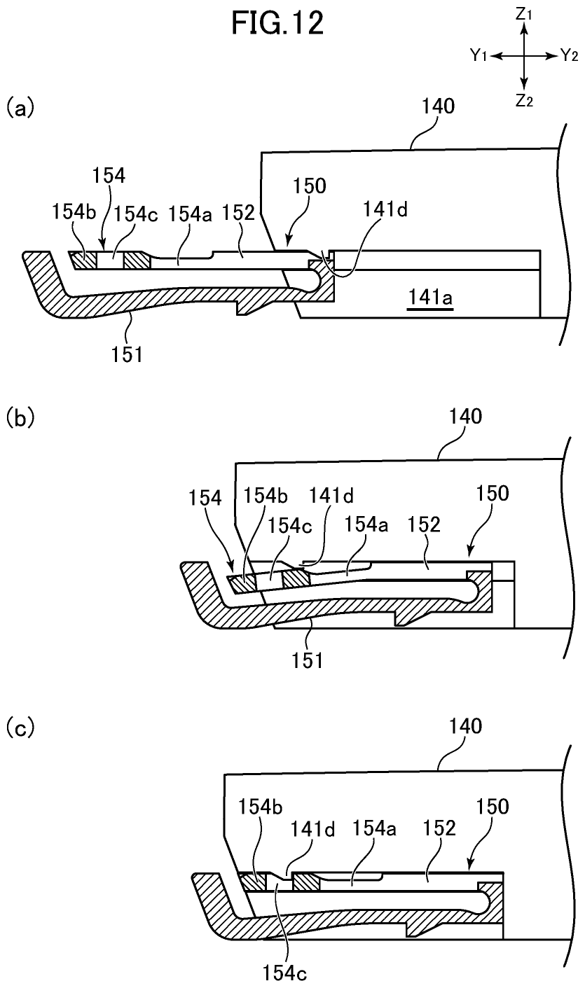

FIG. 12 is a diagram illustrating the movement of the operation member 150 when attached to the UI device 140.

As shown in FIG. 12(a), the operation member 150 is fitted to the accommodating recessed portion 141a of the UI device 140 from the front side. At this time, the guided portions 152a are fitted to the guide portions 141f, and the operation member 150 is moved backward along the guide portions 141f. As shown in FIG. 12(b), the third engaging portion 141d formed in the UI device 140 then interferes with the fourth engaging portion 154b formed in the operation member 150, and the elastic portion 154a is elastically deformed in the downward direction. When the elastic portion 154a is elastically deformed in this manner, the fourth engaging portion 154b passes over the third engaging portion 141d. An inclined surface that is inclined with respect to the attaching direction of the operation member 150 and causes such elastic deformation is formed in each of the third engaging portion 141d and the fourth engaging portion 154b.

As shown in FIG. 12(c), when the fourth engaging portion 154b passes over the third engaging portion 141d, the third engaging portion 141d is fitted to the engagement hole 154c formed in the fourth engaging portion 154b. The inner surface of the engagement hole 154c (the surface facing forward in (c)) and the rear surface of the third engaging portion 141d are substantially perpendicular to the attaching/detaching direction, that is, the front-rear direction of the operation member 150. As such, the third engaging portion 141d restricts the forward movement of the operation member 150.

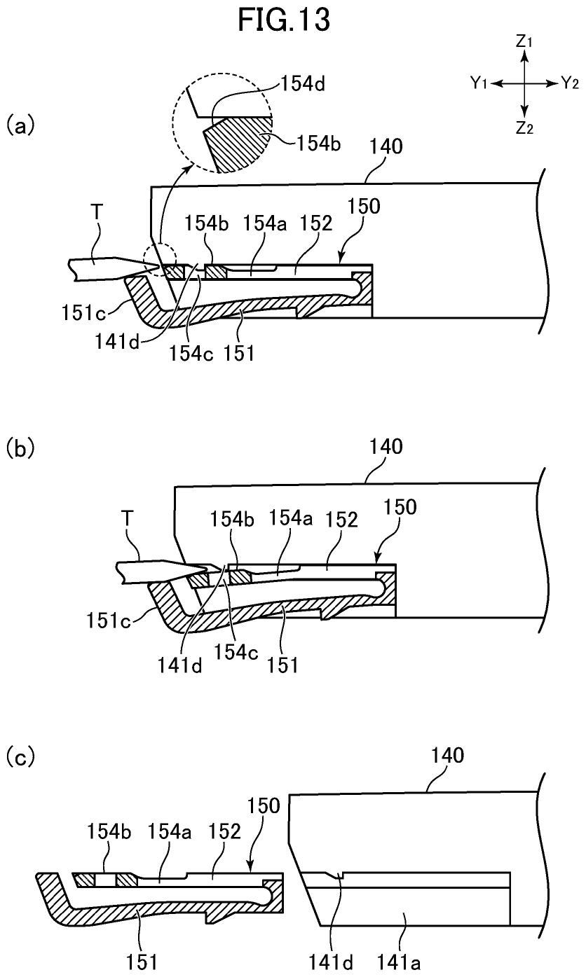

FIG. 13 is a diagram showing the movement of the operation member 150 when being detached from the UI device 140.

As shown in FIG. 13(a) and FIG. 13(b), the user pushes down the fourth engaging portion 154b of the operation member 150 using a tool T. The tool T is a flathead screwdriver, for example, that can be engaged with the front end of the fourth engagement portion 154b. As shown in FIGS. 9 and 13, the operating portion 151c formed in the lower movable portion 151 is extended upward, and the uppermost portion thereof may be located in front of the fourth engaging portion 154b. This prevents an unintended external force from acting on the fourth engaging portion 154b and pushing it down. It may be required to push down the operating portion 151c to enable the tool T to access the front end of the fourth engaging portion 154b.

The elastic portion 154a of the upper movable portion 154 may have a higher stiffness than the elastic portion 151b of the lower movable portion 151. That is, the force required to elastically deform the elastic portion 154a may be larger than the force required to elastically deform the elastic portion 151b. As such, it is possible to more effectively prevent the fourth engaging portion 154b from lowering due to an unintended external force. In the illustrated example, the elastic portion 154a is shorter than the elastic portion 151b, and thus the force required to elastically deform the elastic portion 154a is relatively large.

As shown in FIG. 9, an inclined surface may be formed on an upper edge 154d of the front end of the fourth engaging portion 154b. As shown in FIG. 13(a), such an inclined surface forms a recess between the upper edge 154d and the front edge of the accommodating recessed portion 141a of the UI device 40, and the tip of the tool T may be thereby fitted into the recess.

When the tool T pushes down the fourth engaging portion 154b, the position of the fourth engaging portion 154b is lowered by the elastic deformation of the elastic portion 154a. As shown in FIG. 13(b) and FIG. 13(c), the third engaging portion 141d and the fourth engaging portion 154b are thus disengaged from each other, and the operation member 150 is allowed to slide forward.

As described above, in the examples shown in FIG. 7, for example, the upper movable portion 154 and the third engaging portion 141d form the snap-fit. The snap fit is externally accessible by means of the tool T. The use of the tool T enables the operation member 150 to be detached from the UI device 140. On the other hand, no tool is required to attach or detach the UI device 140 to or from the cradle 160. The user simply slides the UI device 140 along the guide portions 161b, thereby attaching the UI device 140 to the cradle 160. Further, the user simply operates the operating portion 151c of the operation member 150 to slide the UI device 140 forward, thereby removing the UI device 140 from the cradle 160 in the forward direction.

### CONCLUSION

(1) As described above, a UI assembly Sd proposed in the present disclosure includes UI devices 40 and 140, cradles 60 and 160 attached to a bicycle 10 and supporting the UI devices and 140, first engaging portions 61a and 161a provided on the cradles 60 and 160, and operation members 50 and 150 including operating portions 51c and 151c for a user to operate. The operation members 50 and 150 are formed separately from and detachable from the UI devices 40 and 140. The operation members 50 and 150 include second engaging portions 51a and 151a. The second engaging portions 51a and 151a are engaged with the first engaging portions 61a and 161a to prevent the UI devices 40 and 140 from separating from the cradles 60 and 160, and are movable with the operating portions 51c and 151c so that the first engaging portions 61a and 161a and the second engaging portions 51a and 151a are disengaged from each other.

According to the UI assembly Sd, when an unintended external force acts on the operation members 50 and 150 and causes the operating portions 51c and 151c and the second engaging portions 51a and 151a not to move properly, the cradles 60 and 160 and the UI devices 40 and 140 can be used as is by replacing only the operation members 50 and 150 with new ones.

(2) The operation members 50 and 150 are detachable from the UI devices 40 and 140 instead of the cradles 60 and 160. This enables a user to hold the UI devices 40 and 140 with one hand and operate the operating portions 51c and 151c, thereby detaching the UI devices 40 and 140 from the cradles 60 and 160.

(3) In the embodiment shown in FIG. 4A, for example, the UI device 40 is movable in the front-rear direction relative to the cradle 60, and the operating portion 51c of the operation member 50 is movable in the left-right direction. This enables a user to hold the UI device 40 with a finger pushing the operating portion 51c and more smoothly detach the UI device 40 from the cradle 60.

(4) A plurality of contacts 43 and 63 are provided on the UI devices 40 and 140 or the cradles 60 and 160 so as to establish an electrical connection. The operation members 50 and 150 are disposed so as to avoid the contacts 43 and 63. This eliminates the need to form the electrical contacts on the operation members 50 and 150, and thus simplifies the structure of the operation members 50 and 150.

(5) to (7) A mechanism that allows the operation members 50 and 150 to be detached from the UI devices 40 and 140, that is, a screw 81 and a snap fit (upper movable portion 154 and third engaging portion 141d described above), are exposed on the outer surface of the UI devices 40 and 140. This serves to easily change the operation members 50 and 150.

(8) The UI device 40 has a left side surface 41c and a right side surface. The operating portion 51c is provided on the left side surface 41c and not provided on the right side surface. This structure easily ensures a space inside the UI device 40.

(9) The operation member 50 is provided on the left side surface 41c of the UI device 40. This enables the user to easily recognize the position of the operation member 50 when standing on the left side of the bicycle 10.

(10) The operation member 50 includes an elastic portion 51b that supports the operating portion 51c and the second engaging portion 51a. The elastic portion 51b extends along the side surface 41c of the UI device 40. This structure easily secures a sufficiently long length of the elastic portion 51b.

(11), (12) An opening 41d is formed on the side surface 41c of the UI device 40, and the operation member 50 is fitted into the opening 41d. This serves to prevent the operation member 50 from being noticeable. Further, when the UI device 40 is carried, it is possible to protect the operation member 50 and prevent an unintended external force from acting on the operation member 50.

(13) In the example shown in FIG. 7, for example, the operating portion 151c of the operation member 150 is located on the front side of the UI device 140.

(14) In the example shown in FIG. 7, for example, the operating portion 151c is movable in a direction intersecting the surface of the display 40a of the UI device 140.

(15) A drive system proposed in the present disclosure includes the UI assembly Sd described in (1), a control device for controlling an electric motor 14, and a battery 15 for supplying electric power to the electric motor 14.

(16) An electric assisted bicycle 10 proposed in the present disclosure includes the UI assembly Sd described in (1), an electric motor 14, a control device 30 for controlling the electric motor 14, and a battery 15 for supplying electric power to the electric motor 14.

### [Other Modifications]

The UI assembly proposed in the present disclosure is not limited to the above-described embodiment.

For example, the operation members 50 and 150 may be formed separately from the cradles 60 and 160 and detachable from the cradles 60 and 160. The operation members 50 and 150 may be attached to the cradles 60 and 160 with the use of a mechanism, such as a screw and a snap fit, that is accessible from outside using a tool.

In this case, an opening may be formed in the cradle 60, and the operation member 50 may be fitted into the opening. This structure enables the movable portion 51 of the operation member 50 to be protected inside the cradle 60.

The vehicle to which the UI assembly Sd proposed in the present disclosure is applied is not limited to an electric assisted bicycle, and may be applied to, for example, an electric two-wheeled vehicle, a motorcycle powered by an engine, a three-wheeled vehicle (e.g., All Terrain Vehicle), and a four-wheeled vehicle (e.g., Recreational Off-Highway Vehicle).

Although the present invention has been illustrated and described herein with reference to embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A user interface assembly of a vehicle, comprising:
a user interface (UI) device;
a cradle attached to the vehicle and supporting the UI device; and
an operation member including an operating portion for a user to operate,
wherein a first engaging portion is formed on one of either the UI device or the cradle,
the operation member includes a second engaging portion, and is formed separately from and detachable from an other one of either the UI device or the cradle, and
the second engaging portion is engaged with the first engaging portion to prevent the UI device from separating from the cradle and is movable with the operating portion so that the first engaging portion and the second engaging portion are disengaged from each other.

2. The user interface assembly of the vehicle according to claim 1, wherein
the one of the UI device or the cradle is the cradle, and
the other one of the UI device or the cradle is the UI device.

3. The user interface assembly of the vehicle according to claim 2, wherein
the UI device is slidable relative to the cradle in a first direction, and
the operating portion of the operation member is movable in a second direction intersecting the first direction.

4. The user interface assembly of the vehicle according to claim 1, wherein
a plurality of contacts are provided on the UI device or the cradle so as to establish an electrical connection between the UI device or the cradle, and
the operation member is disposed so as to avoid the plurality of contacts.

5. The user interface assembly of the vehicle according to claim 1, comprising a mechanism that allows the operation member to be detached from the other one of the UI device or the cradle, wherein
the mechanism is exposed on an outer surface of the other one of the UI device or the cradle.

6. The user interface assembly of the vehicle according to claim 5, wherein
the mechanism includes a screw.

7. The user interface assembly of the vehicle according to claim 5, wherein
the mechanism includes a snap fit.

8. The user interface assembly of the vehicle according to claim 1, wherein
the other one of the UI device or the cradle includes a first lateral side surface and a second lateral side surface, which is an opposite side surface of the first side surface, and
the operating portion is provided on the first lateral side surface and not on the second lateral side surface.

9. The user interface assembly of the vehicle according to claim 8, wherein
the first lateral side surface faces leftward of the vehicle.

10. The user interface assembly of the vehicle according to claim 1, wherein
the other one of the UI device or the cradle is the UI device,
the operation member includes an elastic portion supporting the operating portion and the second engaging portion, and
the elastic portion extends along a lateral side surface of the UI device.

11. The user interface assembly of the vehicle according to claim 1, wherein
the other one of the UI device or the cradle includes a first lateral side surface,
an opening is formed in the first lateral side surface, and
the operation member is fitted into the opening.

12. The user interface assembly of the vehicle according to claim 1, wherein
the other one of the UI device or the cradle is the UI device,
the UI device includes a first lateral side surface,
an opening is formed in the first lateral side surface, and
the operating portion is fitted into the opening.

13. The user interface assembly of the vehicle according to claim 1, wherein
the operating portion of the operation member is located in a front side or a rear side of the UI device.

14. The user interface assembly of the vehicle according to claim 1, wherein
the UI device includes a display, and
the operating portion is movable in a direction intersecting a surface of the display.

15. A drive system of a vehicle, comprising:
a user interface assembly of a vehicle, comprising:
a user interface (UI) device;
a cradle attached to the vehicle and supporting the UI device; and
an operation member including an operating portion for a user to operate,
wherein a first engaging portion is formed on one of either the UI device or the cradle,
the operation member includes a second engaging portion, and is formed separately from and detachable from another one of either the UI device or the cradle, and
the second engaging portion is engaged with the first engaging portion to prevent the UI device from separating from the cradle and is movable with the operating portion so that the first engaging portion and the second engaging portion are disengaged from each other;
an electric motor;
a control device that controls the electric motor; and
a battery that supplies power to the electric motor.

16. An electric assisted bicycle comprising
a drive system which comprises:
a user interface assembly of a vehicle, comprising:
a user interface (UI) device;
a cradle attached to the vehicle and supporting the UI device; and
an operation member including an operating portion for a user to operate,
wherein a first engaging portion is formed on one of either the UI device or the cradle,
the operation member includes a second engaging portion, and is formed separately from and detachable from another one of either the UI device or the cradle, and
the second engaging portion is engaged with the first engaging portion to prevent the UI device from separating from the cradle and is movable with the operating portion so that the first engaging portion and the second engaging portion are disengaged from each other,
an electric motor;
a control device that controls the electric motor; and
a battery that supplies power to the electric motor.
